(19) United States
(12) Patent Application Publication
(10) Pub. No.: US 2026/0171000 A1
(43) Pub. Date: Jun. 18, 2026

(54) DISPLAY DEVICE AND ELECTRONIC DEVICE

(71) Applicant: Samsung Display Co., Ltd., Yongin-si (KR)

(72) Inventors: Bo Ram SHIN, Yongin-si (KR); Seung Kyu LEE, Yongin-si (KR); Yun Seong KIM, Yongin-si (KR); Sang Wook PARK, Yongin-si (KR); Jung Deok SEO, Yongin-si (KR); Sun Joon HWANG, Yongin-si (KR)

(21) Appl. No.: 19/238,180

(22) Filed: Jun. 13, 2025

(30) Foreign Application Priority Data
Dec. 12, 2024 (KR) 10-2024-0184840

(51) Int. Cl. G09G 3/32; G09G 3/3291

(52) U.S. Cl. CPC G09G 3/32; G09G 3/3291; G09G 2300/043; G09G 2310/0275; G09G 2320/0233; G09G 2320/0242; G09G 2320/0247; G09G 2320/0271; G09G 2330/021; G09G 2330/028

(57) ABSTRACT

A display device includes: a pixel unit including pixels connected to data lines; a data driver configured to selectively apply a data voltage and a park voltage to the data lines; a voltage provider configured to provide the park voltage; and a park voltage determiner configured to independently determine the park voltage according to colors of the pixels based on a display brightness value.

### CROSS-REFERENCE TO RELATED APPLICATION

The present application claims priority to and the benefit of Korean Patent Application No. 10-2024-0184840, filed on Dec. 12, 2024, in the Korean Intellectual Property Office, the entire disclosure of which is incorporated herein by reference.

### BACKGROUND

### 1. Field

Aspects of some embodiments of the present disclosure relate to a display device and an electronic device.

### 2. Description of the Related Art

With the development of information technology, the importance of display devices, which provide a connection medium between users and information, is being highlighted. Accordingly, the use of display devices such as liquid crystal display devices and organic light emitting display devices is increasing.

A display device may include a data driver that provides data voltages to data lines and pixels that display images. The pixels record the data voltages received through the data lines and display images based on the data voltages.

At this time, it is a question of which voltage to apply to the data line during a period in which data voltages are not provided. The trade-off relationship between power consumption and image quality may desirably be considered.

The above information disclosed in this Background section is only for enhancement of understanding of the background and therefore the information discussed in this Background section does not necessarily constitute prior art.

### SUMMARY

Aspects of some embodiments include a display device and an electronic device capable of maintaining relatively high image quality while relatively reducing power consumption.

A display device according to some embodiments includes: a pixel unit including pixels connected to data lines; a data driver that selectively applies a data voltage and a park voltage to the data lines; a voltage provider that provides the park voltage; and a park voltage determiner that independently determines the park voltage according to colors of the pixels based on a display brightness value.

According to some embodiments, the display device may display an image in a plurality of modes. According to some embodiments, the plurality of modes may include a first mode of displaying an image at a first frequency and a second mode of displaying an image at a second frequency. According to some embodiments, the park voltage may be a first park voltage. According to some embodiments, the first park voltage is provided to the data lines in the first mode for a first period.

According to some embodiments, the park voltage may be a second park voltage. According to some embodiments, the second park voltage may be provided to the data lines in the second mode for a second period.

According to some embodiments, the second frequency may be smaller than the first frequency. According to some embodiments, the second period may be longer than the first period.

According to some embodiments, the park voltage determiner may determine a reference grayscale for each color of the pixels corresponding to the display brightness value, and may determine a reference voltage corresponding to the reference grayscale as the park voltage.

According to some embodiments, the pixels may include first pixels of a first color, second pixels of a second color, and third pixels of a third color. According to some embodiments, the reference grayscale of the second pixels may be the same in all ranges of the display brightness value.

According to some embodiments, the reference grayscale of the third pixels in a first range of the display brightness value may be different from the reference grayscales of the third pixels of a second range of the display devices brightness value.

According to some embodiments, the park voltage may be recorded in a lookup table.

According to some embodiments, the display device may display an image in a plurality of modes. According to some embodiments, the plurality of modes may include a first mode of displaying an image at a first frequency and a second mode of displaying an image at a second frequency. According to some embodiments, the park voltage determiner may determine an initial park voltage such that a luminance difference between the first mode and the second mode is below a predetermined value.

According to some embodiments, the park voltage determiner may determine a final park voltage so that a color coordinate difference between the first mode and the second mode is below a predetermined threshold. According to some embodiments, the final park voltage may be the park voltage.

An electronic device according to some embodiments includes: a processor that provides image data; and a display device that displays an image based on grayscales of the image data. According to some embodiments, the display device may include: a pixel unit including pixels connected to data lines; a data driver that selectively applies a data voltage and a park voltage to the data lines; a voltage provider that provides the park voltage; and a park voltage determiner that independently determines the park voltage according to colors of the pixels based on a display brightness value.

According to some embodiments, the display device may display an image in a plurality of modes. According to some embodiments, the plurality of modes may include a first mode of displaying an image at a first frequency and a second mode of displaying an image at a second frequency. According to some embodiments, the park voltage may be a first park voltage. According to some embodiments, the first park voltage may be provided to the data lines in the first mode for a first period.

According to some embodiments, the park voltage may be a second park voltage. According to some embodiments, the second park voltage may be provided to the data lines in the second mode for a second period of time.

According to some embodiments, the second frequency may be smaller than the first frequency. According to some embodiments, the second period may be longer than the first period.

According to some embodiments, the park voltage determiner may determine a reference grayscale for each color of the pixels corresponding to the display brightness value, and may determine a reference voltage corresponding to the reference grayscale as the park voltage.

According to some embodiments, the pixels may include first pixels of a first color, second pixels of a second color, and third pixels of a third color. According to some embodiments, the reference grayscale of the second pixels may be the same in all ranges of the display brightness value.

According to some embodiments, the reference grayscale of the third pixels in a first range of the display brightness value may be different from the reference grayscale of the third pixels of a second range of the display devices brightness value.

According to some embodiments, the park voltage may be recorded in a lookup table.

According to some embodiments, the display device may display an image in a plurality of modes. According to some embodiments, the plurality of modes may include a first mode of displaying an image at a first frequency and a second mode of displaying an image at a second frequency. According to some embodiments, the park voltage determiner may determine an initial park voltage such that a luminance difference between the first mode and the second mode is below a predetermined value.

According to some embodiments, the park voltage determiner may determine a final park voltage so that a color coordinate difference between the first mode and the second mode is below a predetermined threshold. According to some embodiments, the final park voltage is the park voltage.

### BRIEF DESCRIPTION OF THE DRAWINGS

The above and other features of some embodiments of the present disclosure will become more apparent by describing in further detail aspects of some embodiments thereof with reference to the accompanying drawings, in which:

FIG. 1 is a diagram illustrating a display device according to some embodiments of the present disclosure.

FIG. 2 is a diagram illustrating a pixel according to some embodiments of the present disclosure.

FIGS. 3 to 6 are diagrams for describing a change in a display frequency according to some embodiments of the present disclosure.

FIG. 7 is a diagram illustrating an address scan period according to some embodiments of the present disclosure.

FIG. 8 is a diagram illustrating a self-scan period according to some embodiments of the present disclosure.

FIG. 9 is a diagram illustrating an auxiliary scan period according to some embodiments of the present disclosure.

FIG. 10 is a diagram for describing a mode and a park voltage of a display device according to some embodiments of the present disclosure.

FIG. 11 is a diagram illustrating a park voltage determiner according to some embodiments of the present disclosure.

FIG. 12 is a diagram illustrating a lookup table of a park voltage determiner according to some embodiments of the present disclosure.

FIGS. 13 and 14 are diagrams for describing a process of determining a park voltage.

FIG. 15 is a block diagram of an electronic device according to some embodiments.

FIGS. 16 to 18 are schematic diagrams of an electronic device according to some embodiments.

### DETAILED DESCRIPTION

Hereinafter, aspects of some embodiments of the present disclosure will be described in more detail with reference to the accompanying drawings so that those skilled in the art can easily implement the embodiments. The present disclosure may be implemented in various different forms and is not limited to the embodiments described herein.

In order to more clearly explain the present disclosure, parts unrelated to the description are omitted, and the same or similar components are denoted by the same reference numerals throughout the specification. Therefore, the reference numerals described above can also be used in other drawings.

In addition, because the size and thickness of each component shown in the drawings are arbitrarily shown for convenience of description, the present disclosure is not necessarily limited to what is shown. In the drawings, thicknesses may be exaggerated to clearly represent various layers and regions.

Also, the expression “same” in the description may mean “substantially the same”. That is, it may be the same to the extent that a person with ordinary knowledge can understand that they are the same. Other expressions may also be expressions in which “substantially” is omitted.

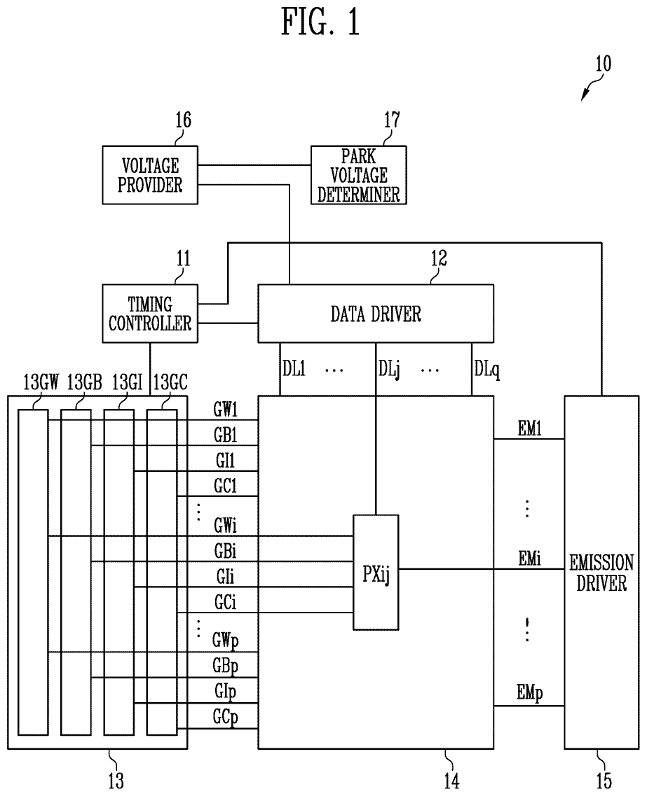

FIG. 1 is a diagram illustrating a display device according to some embodiments of the present disclosure.

Referring to FIG. 1, a display device 10 according to some embodiments of the present disclosure may include a timing controller 11, a data driver 12, a scan driver 13, a pixel unit 14, an emission driver 15, a voltage provider 16, and a park voltage determiner (or park voltage determination circuit or component) 17.

The timing controller 11 may receive grayscales for an input image (or an input frame). The grayscales may include a first color grayscale, a second color grayscale, and a third color grayscale. The first color grayscale is a grayscale for expressing the first color, the second color grayscale is a grayscale for expressing the second color, and the third color grayscale is a grayscale for expressing the third color.

Further, the timing controller 11 may receive a control signal for an image. Such a control signal may include a horizontal synchronization signal (Hsync), a vertical synchronization signal (Vsync), and a data enable signal. The vertical synchronization signal may include a plurality of pulses, and may indicate that a previous frame period ends and a current frame period begins based on a time point at which each of the pulses occurs. The interval between adjacent pulses of the vertical synchronization signal may correspond to one frame period. The horizontal synchronization signal may include a plurality of pulses, and may indicate that a previous horizontal period ends and a new horizontal period begins based on a time point at which each pulse occurs. The interval between adjacent pulses of the horizontal synchronization signal may correspond to one horizontal period. The data enable signal may have an enable level for certain horizontal periods and may have a disable level for the rest of the period. When the data enable signal is at the enable level, it may indicate that color grayscales are supplied in corresponding horizontal periods.

The timing controller 11 may provide the data driver 12 with grayscales rendered or corrected to meet the specifications of the display device 10. Further, the timing controller 11 may provide a clock signal, a scan start signal, and the like to the scan driver 13. The timing controller 11 may provide a clock signal, an emission stop signal, and the like to the emission driver 15.

The data driver 12 may use the grayscales and control signals received from the timing controller 11 to generate data voltages to provide to the data lines DL1, . . . , DLj, . . . , and DLq. For example, the data driver 12 may sample grayscales using a clock signal and apply data voltages corresponding to the grayscales to the data lines in units of pixel rows. q may be an integer greater than 1, and j may be an integer larger than 0 and smaller than q.

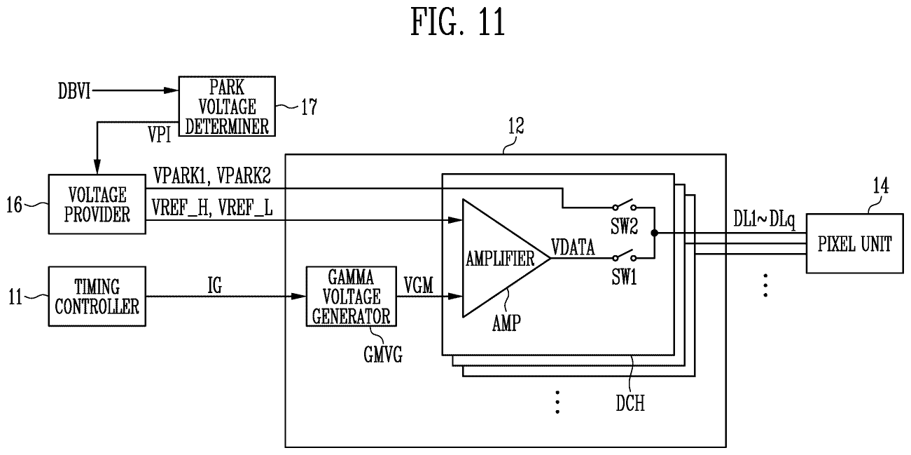

According to some embodiments, the data driver 12 may selectively apply a data voltage and a park voltage to the data lines DL1 to DLq. The voltage provider 16 may provide a park voltage. The park voltage determiner 17 may independently determine the park voltage according to the colors of the pixels based on the display brightness value. Detailed configurations and operations of the data driver 12, the voltage provider 16, and the park voltage determiner 17 will be described in more detail below with reference to FIG. 11.

The scan driver 13 may include first to fourth scan drivers 13GW, 13GB, 13GI, and 13GC. The first scan driver 13GW may provide first scan signals to the first scan lines GW1, . . . , GWi, . . . , and GWp. p may be an integer greater than 1, and i may be an integer larger than 0 and smaller than p. The second scan driver 13GB may provide second scan signals to the second scan lines GB1, . . . , GBi, . . . , and GBp. The third scan driver 13GI may provide third scan signals to the third scan lines GI1, . . . , GIi, . . . , and GIp. The fourth scan driver 13GC may provide fourth scan signals to the fourth scan lines GC1, . . . , GCi, . . . , and GCp.

For example, the first scan driver 13GW may receive at least one scan clock signal and a scan start signal from the timing controller 11 to generate first scan signals to be provided to the first scan lines GW1 to GWp. The first scan driver 13GW may sequentially provide first scan signals having a turn-on level of pulse to the first scan lines GW1 to GWp. For example, the first scan driver 13GW may be configured in the form of a shift register, and may generate the first scan signals by sequentially transmitting a scan start signal in the form of a pulse of a turn-on level to a next scan stage according to control of the scan clock signal.

Each of the second scan driver 13GB, the third scan driver 13GI, and the fourth scan driver 13GC may be configured similarly to the first scan driver 13GW, and thus a redundant description thereof will be omitted. According to some embodiments, at least some of the first to fourth scan drivers 13GW, 13GB, 13GI, and 13GC may be integrated.

The emission driver 15 may receive at least one emission clock signal and an emission stop signal from the timing controller 11 to generate emission signals to be provided to the emission lines EM1, . . . , EMi, . . . , and EMp. The emission driver 15 may sequentially provide emission signals having a turn-off level pulse to the emission lines EM1 to EMp. For example, the emission driver 15 may be configured in the form of a shift register, and may generate emission signals by sequentially transmitting an emission stop signal in the form of pulse of a turn-off level to a next emission stage according to control of the emission clock signal.

In FIG. 1, the first scan lines GW1 to GWp, the second scan lines GB1 to GBp, the third scan lines GI1 to GIp, the fourth scan lines GC1 to GCp, and the emission lines EM1 to EMp are shown as p, respectively. However, according to some embodiments, at least one of the second scan lines GB1 to GBp, the third scan lines GI1 to GIp, the fourth scan lines GC1 to GCp, or the emission lines EM1 to EMp may be configured to be equal to or less than p/2. For example, two adjacent pixel rows may share one second scan line. Similarly, two adjacent pixel rows may share one third scan line, a fourth scan line, or an emission line. The same pixel row means pixels connected to the same first scan line.

The pixel unit 14 (or the display panel) includes a plurality pixels. Although FIG. 1 illustrates a single pixel PXij for convenience of illustration, as a person having ordinary skill in the art would appreciate, the pixel unit 14 may include any suitable number of pixels according to the design and size of the pixel unit 14. Each pixel PXij may be connected to a corresponding data line DLj, scan lines GWi, GBi, GIi, GCi, and emission line EMi. Each pixel PXij may include a light emitting element that emits light based on the received data voltage.

The pixel unit 14 may include first pixels emitting light of a first color, second pixels emitting light of the second color, and third pixels emitting light of third color. The first color, the second color, and the third color may be different colors. For example, the first color may be one of red, green, and blue, the second color may be one color other than the first color among red, green, or blue, and the third color may be the rest of the colors other than the first and second colors among red, green and blue. In addition, magenta, cyan, and yellow may be used instead of red, green, and blue in the first to third colors.

The pixel unit 14 may be arranged in various forms such as diamond pentile (diamond PENTILET), RGB-stripe, S-stripe, real RGB, and normal pentile (normal PENTILE™).

At least some of the timing controller 11, the data driver 12, the scan driver 13, the emission driver 15, the voltage provider 16, and the park voltage determiner 17 may be configured as one integrated circuit. In addition, at least some of the timing controller 11, the data driver 12, the scan driver 13, the emission driver 15, the voltage provider 16, and the park voltage determiner 17 may be configured to be separated into two or more circuits. Separately configured circuits may be included as part of other circuits.

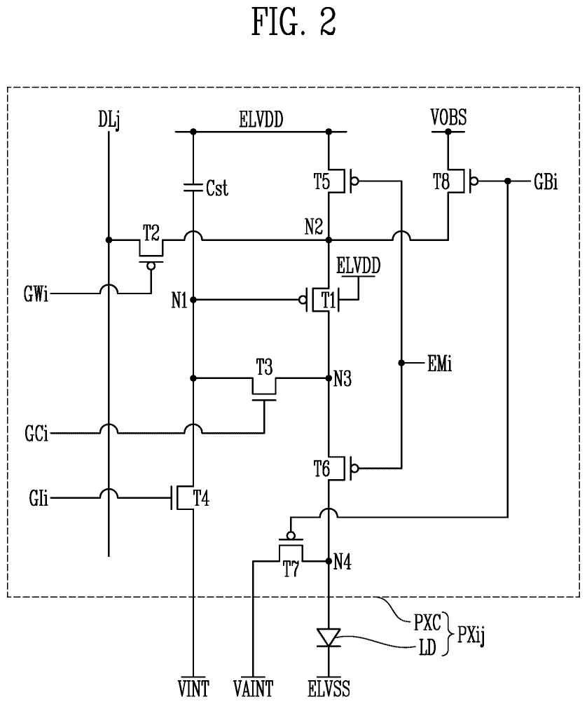

FIG. 2 is a diagram illustrating a pixel according to some embodiments of the present disclosure. Although FIG. 2 illustrates various components in a pixel according to some embodiments, embodiments according to the present disclosure are not limited thereto, and according to various embodiments, the pixel may include additional components or fewer components without departing from the spirit and scope of embodiments according to the present disclosure.

Referring to FIG. 2, the pixel PXij may include a pixel circuit PXC and a light emitting element LD. The pixel circuit PXC includes transistors T1, T2, T3, T4, T5, T6, T7, and T8, and a storage capacitor Cst.

The pixel PXij may be located in an i-th pixel row and may be located in a j-th pixel column. The pixel PXij may be a first pixel for expressing a first color. Because the second pixel for expressing the second color and the third pixel for expressing the third color may be configured in the same manner as the first pixel, redundant description is omitted.

The P-type transistors may be polysilicon semiconductor transistors. In the polysilicon semiconductor transistor, the channel of the active layer may include a polysilicon semiconductor. For example, the polysilicon semiconductor transistor may be a low temperature poly-silicon (LTPS) thin film transistor. The polysilicon semiconductor transistor has high electron mobility and thus has fast driving characteristics.

The N-type transistors may be oxide semiconductor transistors. In the oxide semiconductor transistor, the channel of the active layer may include an oxide semiconductor. For example, the oxide transistor may be a low temperature polycrystalline oxide (LTPO) thin film transistor. The oxide semiconductor transistor has a lower charge mobility than the polysilicon semiconductor transistor. Accordingly, the amount of leakage current generated in the turn-off state of the oxide semiconductor transistors may be smaller than that of the polysilicon semiconductor transistors.

The first transistor T1 may have a gate electrode connected to the first node N1, a first electrode connected to the second node N2, and a second electrode connected to the third node N3. The first transistor T1 may be a driving transistor. The first transistor T1 may be a P-type transistor. According to some embodiments, the first transistor T1 may include a sub-gate electrode (or a back-gate electrode, a body), and the sub-gate electrode may receive the first power supply voltage ELVDD. According to some embodiments, the sub-gate electrode of the first transistor T1 may be connected to a gate electrode (that is, a first node). According to some embodiments, the sub-gate electrode of the first transistor T1 may not be present.

The second transistor T2 may have a gate electrode connected to the first scan line GWi, a first electrode connected to the data line DLj, and a second electrode connected to the second node N2. The second transistor T2 may be a switching transistor. The second transistor T2 may be a P-type transistor.

The first scan driver 13GW may provide a first scan signal for controlling timing at which the pixel PXij receives a data voltage. For example, the second transistor T2 that has received the first scan signal at the turn-on level may be turned on, and the second transistor T2 may apply a data voltage applied to the data line DLj to the second node N2.

The third transistor T3 may have a gate electrode connected to the fourth scan line GCi, a first electrode connected to the first node N1, and a second electrode connected to the third node N3. The third transistor T3 may be a diode-connected transistor. The third transistor T3 may be an N-type transistor.

The fourth transistor T4 may have a gate electrode connected to the third scan line GIi, a first electrode connected to the first node N1, and a second electrode receiving the first initialization voltage VINT. The fourth transistor T4 may be a gate initialization transistor. The fourth transistor T4 may be an N-type transistor.

In the fifth transistor T5, a gate electrode may be connected to the emission line EMi, a first electrode may receive the first power supply voltage ELVDD, and a second electrode may be connected with the second node N2. The fifth transistor T5 may be a first emission control transistor. The fifth transistor T5 may be a P-type transistor.

The sixth transistor T6 may have a gate electrode connected to the emission line EMi, a first electrode connected to the third node N3, and a second electrode connected to the fourth node N4. The sixth transistor T6 may be a second emission control transistor. The sixth transistor T6 may be a P-type transistor.

The seventh transistor T7 may have a gate electrode connected to the second scan line GBi, a first electrode receiving a second initialization voltage VAINT (or an anode initialization voltage), and a second electrode connected to the fourth node N4. The seventh transistor T7 may be an anode initialization transistor. The seventh transistor T7 may be a P-type transistor.

The second scan driver 13GB may provide a second scan signal for controlling the timing of application of the second initialization voltage VAINT (or the anode initialization voltage) to the anode electrode of the light emitting element LD. For example, the seventh transistor T7 that has received the second scan signal at the turn-on level is turned on, and the second initialization voltage VAINT is applied to the anode of the light emitting element LD, so that the anode voltage of the light emitting element LD can be initialized to the second initialization pressure VAINT.

In the eighth transistor T8, a gate electrode may be connected to the second scan line GBi, a first electrode may receive the bias voltage VOBS, and a second electrode may be connected with the second node N2. The eighth transistor T8 may be a bias transistor. The eighth transistor T8 may be a P-type transistor.

In the storage capacitor Cst, the first electrode may receive the first power supply voltage ELVDD, and the second electrode may be connected to the first node N1.

In the light emitting element LD, an anode electrode may be connected to the fourth node N4, and a cathode electrode may receive the second power supply voltage ELVSS. The light emitting element LD may emit light in one of a first color, a second color, and a third color. The light emitting element LD may be a light emitting diode. The light emitting element LD may be composed of an organic light emitting diode, an inorganic light emitting diode, a quantum dot/well light emitting diode, or the like. According to some embodiments, only one light emitting element LD is provided in each pixel, but according to some embodiments, a plurality of light emitting elements may be provided in each pixel. In this case, a plurality of light emitting elements may be connected in series, parallel, or in series-parallel.

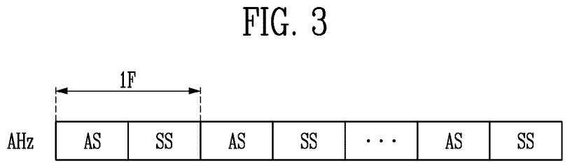

FIGS. 3 to 6 are diagrams for describing a change in a display frequency according to some embodiments of the present disclosure.

The display device 10 can support a variable refresh rate. The refresh rate is a frequency at which a data voltage is written to the pixel PXij, also referred to as a screen scan rate and a screen reproduction rate, and may indicate the number of image frames reproduced for one second.

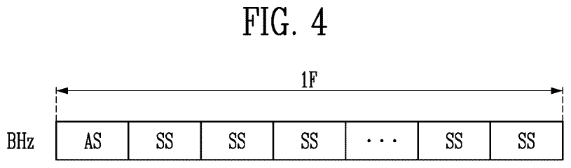

The pixel unit 14 may display an image at a first frequency AHz in the first mode (see FIG. 3) and display an image at the second frequency BHz smaller than the first frequency AHz (see FIG. 4) in the second mode.

For example, each frame period 1F in the first mode may include, for each pixel PXij, one address scan period AS. According to some embodiments, each frame period 1F in the first mode may further include, for each pixel PXij, one Self Scan Period (SS).

For example, each frame period 1F in the second mode may include, for each pixel PXij, one address scan period AS and a plurality of self-scan periods SS. As the second frequency BHz is smaller, the number of self-scan periods SS included in one frame period 1F may increase. For another example, each frame period 1F in a particular mode may include, for each pixel PXij, only one address scan period AS, and not a self-scan period SS.

The address scan period AS is a period in which a data voltage is written to the pixel PXij. The address scan period AS may be referred to as a data programming period that receives a data voltage from the data line DLj.

The self-scan period SS is a period in which a data voltage is not written to the pixel PXij. During the emission period of the self-scan period SS, the pixel PXij may emit light using the data voltage written in the address scan period AS. For example, the length of the self-scan period SS may be the same as the length of the address scan period AS. According to some embodiments, the length of the self-scan period SS may be shorter than the length of the address scan period AS. For example, the length of the self-scan period SS may correspond to half of the length of the address scan period AS. For another example, the length of the address scan period AS may be an integer multiple of the length of the self-scan period SS.

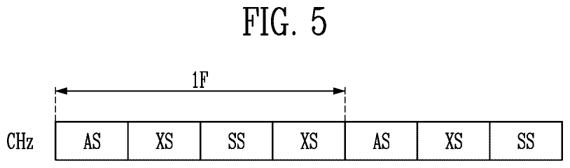

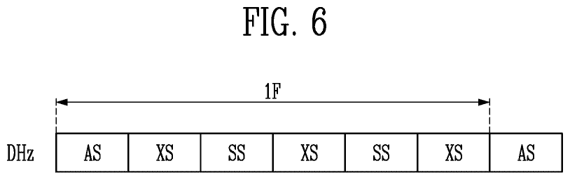

The pixel unit 14 may display an image at a third frequency CHz in the third mode (see FIG. 5) and display an image at the fourth frequency DHz smaller than the third frequency CHz (see FIG. 6) in the fourth mode.

In the third mode and the fourth mode, an auxiliary scan period XS subsequent to the address scan period AS and an auxiliary scan period XS subsequent to the self-scan period SS may be included.

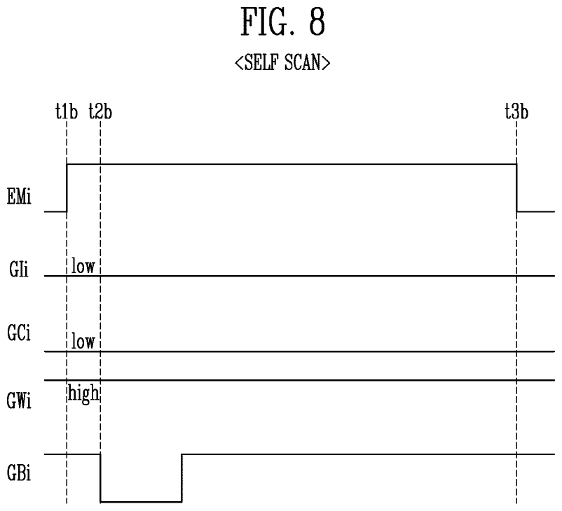

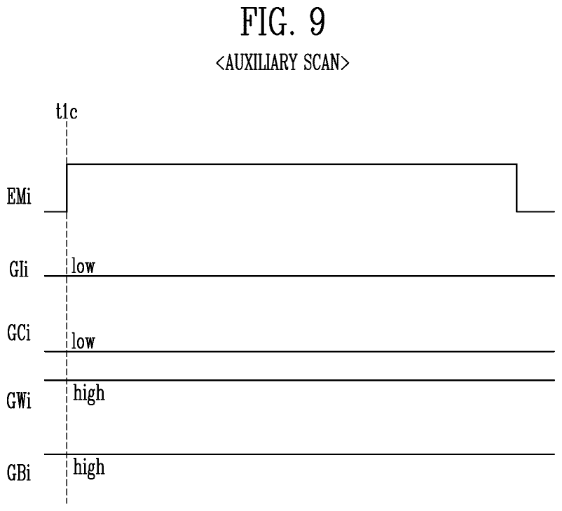

The auxiliary scan period XS may be similar to the self-scan period SS in that it is a period in which the data voltage is not written to the pixel PXij. During the emission period of the auxiliary scan period XS, the pixel PXij may emit light using the data voltage written in the address scan period AS. For example, the length of the auxiliary scan period XS may be the same as the length of the address scan period AS. However, the auxiliary scan period XS is different from the self-scan period SS in that the second scan signal at the turn-on level is not supplied. For this, refer to the following description of FIGS. 8 and 9.

The display device 10 may display an image in a plurality of modes. The display device 10 does not necessarily include all of the first mode, the second mode, the third mode, and the fourth mode to be driven. The display device 10 may be driven only in at least one of the first mode, the second mode, the third mode, or the fourth mode. For example, the display device 10 may be driven in only one of the first mode, the second mode, the third mode, and the fourth mode. Further, the display device 10 may be driven only in the first mode and the second mode, and may not be driven in the third mode and the fourth mode. Meanwhile, the display device 10 may be driven only in the third mode and the fourth mode, and may not be driven in the first mode and the second mode.

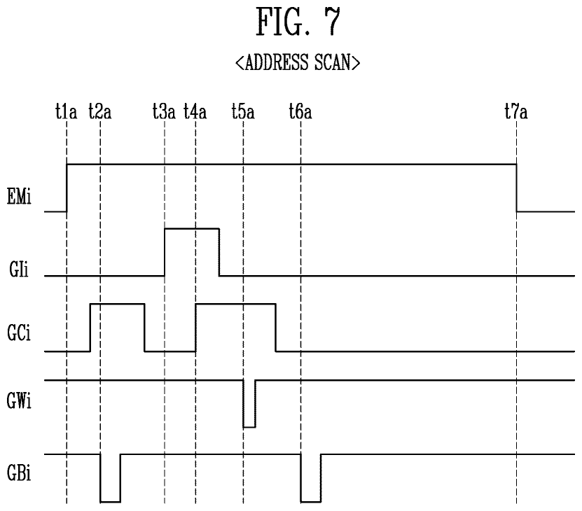

FIG. 7 is a diagram illustrating an address scan period according to some embodiments of the present disclosure. In describing FIG. 7, the pixel PXij of FIG. 2 is referred.

At the time point t1a, an emission signal at a turn-off level (high level) is applied to the emission line EMi, so that the fifth transistor T5 and the sixth transistor T6 are turned off, and the pixel PXij is in a non-emission state.

At the time point t2a, a second scan signal at a turn-on level (low level) is applied to the second scan line GBi, whereby the seventh transistor T7 and the eighth transistor T8 are turned on. Further, a fourth scan signal at a turn-on level (high level) is applied to the fourth scan line GCi, whereby the third transistor T3 is turned on. In this case, a bias voltage VOBS higher than the gate electrode (first node N1) is applied to the source electrode (second node N2) of the first transistor T1, whereby the first transistor T1 may be on-biased. When the first transistor T1 is on-biased, the data voltage of the current frame input thereafter may be lower than the bias voltage VOBS. Thus, hysteresis may be prevented or reduced regardless of the magnitude of the data voltage of the previous frame.

For reference, a hysteresis phenomenon refers to a phenomenon in which a source-drain current curve versus a gate-source voltage of a transistor when a data voltage of a current frame is higher than a data voltage of the previous frame is different from a source-dray current curve versus a gateway-source voltage of the transistor when the data voltage of the current frame is lower than the data voltage of a previous frame.

At the time point t3a, a third scan signal at a turn-on level (high level) is applied to the third scan line GIi, whereby the fourth transistor T4 is turned on. Accordingly, the first initialization voltage VINT is applied to the first node N1. The first initialization voltage VINT is a sufficiently low voltage, and the first transistor T1 may be turned on.

At the time point t4a, a fourth scan signal at a turn-on level (high level) is applied to the fourth scan line GCi, whereby the third transistor T3 is turned on. Accordingly, the first transistor T1 is in a diode-connected state in which a drain electrode and a gate electrode are connected.

At the time point t5a, a scan signal at a turn-on level (low level) is applied to the first scan line GWi, whereby the second transistor T2 is turned on. Accordingly, the data voltage of the data line DLj may be applied to the first node N1 through the second transistor T2, the first transistor T1, and the third transistor T3 which are in the turn-on state. In this case, the voltage of the first node N1 may be a compensation voltage obtained by subtracting the threshold voltage of the first transistor T1 from the data voltage. The storage capacitor Cst may maintain a difference between the first power supply voltage ELVDD and the compensation voltage.

At the time point t6a, a scan signal at a turn-on level (low level) is applied to the second scan line GBi, whereby the seventh transistor T7 and the eighth transistor T8 are turned on. As the seventh transistor T7 is turned on, a second initialization voltage VAINT is applied to the anode of the light emitting element LD, and the light emitting element LD may be initialized with an amount of charge corresponding to a voltage difference between the second initialization voltage VAINT and the second power supply voltage ELVSS. Accordingly, low-grayscale representation of the light emitting element LD can be facilitated.

At the time point t7a, the fifth transistor T5 and the sixth transistor T6 may be turned on by applying an emission signal at a turn-on level (low level) to the emission line EMi. Accordingly, a path of a driving current flowing from the first power supply voltage ELVDD toward the second power supply voltage ELVSS via the fifth transistor T5, the first transistor T1, the sixth transistor T6, and the light emitting element LD is formed.

The amount of driving current may be adjusted according to the voltage held in the storage capacitor Cst. The light emitting element LD emits light with luminance corresponding to the amount of driving current. The light emitting element LD may emit light until an emission signal at a turn-off level is applied to the emission line EMi.

FIG. 8 is a diagram illustrating a self-scan period according to some embodiments of the present disclosure. In describing FIG. 8, refer to the pixel PXij of FIG. 2.

At the time point t1b, an emission signal at a turn-off level (high level) is applied to the emission line EMi, so that the fifth transistor T5 and the sixth transistor T6 are turned off, and the pixel PXij is in a non-emission state.

During the self-scan period t1b to t3b, scan signals at the turn-off level are maintained in the first scan line GWi, the third scan line GIi, and the fourth scan line GCi. Accordingly, the voltage of the first node N1 is not changed.

At the time point t2b, a scan signal at a turn-on level (low level) is applied to the second scan line GBi, whereby the seventh transistor T7 and the eighth transistor T8 are turned on. As the seventh transistor T7 is turned on, a second initialization voltage VAINT is applied to the anode of the light emitting element LD, and the light emitting element LD may be initialized with an amount of charge corresponding to a voltage difference between the second initialization voltage VAINT and the second power supply voltage ELVSS. Accordingly, low-grayscale representation of the light emitting element LD can be facilitated. Further, as the eighth transistor T8 is turned on, the source voltage of the first transistor T1 may be initialized. Accordingly, it is possible to prevent or reduce the gate-source voltage difference of the first transistors T1 from undesirably changed due to the shaken source voltage of the first transistor T1.

At the time point t3b, the fifth transistor T5 and the sixth transistor T6 may be turned on by applying an emission signal at a turn-on level (low level) to the emission line EMi. Accordingly, a path of a driving current flowing from the first power supply voltage ELVDD toward the second power supply voltage ELVSS via the fifth transistor T5, the first transistor T1, the sixth transistor T6, and the light emitting element LD is formed.

The amount of driving current may be adjusted according to the voltage held in the storage capacitor Cst. Because the voltage of the first node N1 recorded during the address scan period AS is maintained during the self-scan period SS, the luminance of the light emitting element LD in the self-scan period SS may be the same as the luminance in the light emitting element LD in the address scan period AS.

FIG. 9 is a diagram illustrating an auxiliary scan period according to some embodiments of the present disclosure.

The auxiliary scan period of FIG. 9 is an example of the auxiliary scan period XS of FIGS. 5 and 6. During the auxiliary scan period of FIG. 9, the emission signal of the emission line EMi may have the same waveform as the signals of the address scan period in FIG. 7. However, the first to fourth scan signals may maintain a turn-off level. Accordingly, the voltage of the first node N1 is not changed, and a voltage difference between both ends of the storage capacitor Cst may be maintained. Accordingly, the luminance of the light emitting element LD after the auxiliary scan period of FIG. 9 may be the same as the luminance of the light emitting element LD after the immediately preceding address scan period.

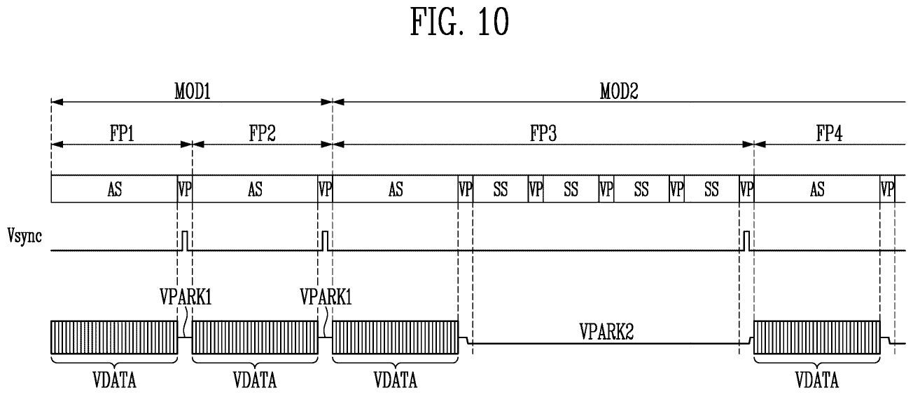

FIG. 10 is a diagram for describing a mode and a park voltage of a display device according to some embodiments of the present disclosure.

Referring to FIG. 10, an example in which the display device 10 is sequentially driven in the first mode MOD1 and the second mode MOD2 is disclosed. For example, during the first frame period FP1 and the second frame period FP2, the display device 10 may be driven in the first mode MOD1. Next, during the third frame period FP3 and the fourth frame period FP4, the display device 10 may be driven in the second mode MOD2.

The first mode MOD1 may be a mode in which an image is displayed at a first frequency, and the second mode MOD2 may be a mode of displaying an image at a second frequency. The second frequency may be less than the first frequency. Accordingly, each of the third frame period FP3 and the fourth frame period FP4 may be longer than each of the first frame period FP1 and the second frame period FP2.

It is assumed that each of the frame periods FP1 and FP2 in the first mode MOD1 includes one address scan period AS and a porch period VP. It is assumed that each of the frame periods FP3, FP4 in the second mode MOD2 includes one address scan period AS, a plurality of self-scan periods SS, and a plurality of porch periods VP. The porch period VP may be a transitional period between adjacent scan periods.

The processor may transmit the vertical synchronization signal Vsync and the image data. The vertical synchronization signal Vsync may include a plurality of pulses, and may indicate that a previous frame period ends and a current frame period begins based on a time point at which each of the pulses occurs. The interval between adjacent pulses of the vertical synchronization signal Vsync may correspond to one frame period. A pulse of the vertical synchronization signal Vsync may occur in the porch period VP immediately before the address scan period AS.

The data driver 12 may selectively apply the data voltages VDATA and the park voltages VPARK1 and VPARK2 to the data lines DL1 to DLq. The park voltages VPARK1 and VPARK2 may be voltages during an idle period that are not recorded in the pixel and are applied only to the data lines DL1 to DLq. By applying the park voltages VPARK1 and VPARK2 instead of the data voltages VDATA during the idle period, it is possible to reduce the power consumption of the data driver 12.

The first park voltage VPARK1 may be provided to the data lines DL1 to DLq in the first mode MOD1 for a first period. According to some embodiments, the first period of time may include a porch period VP immediately prior to the address scan period AS. According to some embodiments, the first period may include a porch period VP immediately following the address scan period AS. According to some embodiments, the first period may include a porch period VP immediately before and after the address scan period AS.

According to some embodiments, the first period may include a porch period VP immediately before or after the second park voltage VPARK2 is applied. For example, the first park voltage VPARK1 may be provided to the data lines DL1-DLq in the second mode MOD2.

The second park voltage VPARK2 may be provided to the data lines DL1 to DLq in the second mode MOD2 for a second period. The second park voltage VPARK2 may not be provided to the data lines DL1 to DLq in the first mode MOD1. According to some embodiments, the second period may include a porch period VP between adjacent self-scan periods SS. According to some embodiments, the second period may include a porch period VP between an address scan period AS and a self-scan period SS. The second period in which the second park voltage VPARK2 is continuously applied may be longer than the first period in which the first park voltage VARK1 is continuously applied.

In some cases, image quality degradation due to the park voltages VPARK1 and VPARK2 may occur. For example, timing at which the data driver 12 applies the first park voltage VPARK1 and timing at which the second scan driver 13GB supplies the second scan signals at the turn-on level may overlap in time. In this case, noise may occur in the voltage of the second node N2 of the pixel PXij due to voltage coupling, and the gate-source voltage difference of the first transistor T1 may not be maintained. Therefore, it may lead to a decrease in image quality.

Meanwhile, timing at which the data driver 12 applies the second park voltage VPARK2 and timing at which the second scan driver 13GB supplies the second scan signals at the turn-on level may overlap in time. In particular, because the second park voltage VPARK2 is applied for a relatively long time, voltage coupling may appear throughout the pixel unit 14. In this case, an undesirable flicker phenomenon may occur.

FIG. 11 is a diagram illustrating a park voltage determiner according to some embodiments of the present disclosure.

The park voltage determiner 17 may independently determine the park voltages VPARK1 and VPARK2 according to colors of pixels based on the display brightness value DBVI. The park voltage determiner 17 may provide park voltage information VPI for the determined voltage levels of the park voltages VPARK1 and VPARK2.

The display brightness value DBVI may be the luminance of light emitted from pixels set to the maximum grayscale. For example, the display brightness value DBVI may be a luminance (maximum luminance) of white light generated by all pixels of the pixel unit 14 corresponding to white grayscale. The unit of luminance may be Nit. The display brightness value DBVI may be manually set by a user's operation on the display device 10, or may be automatically set by an algorithm associated with an illuminance sensor or the like. For example, a maximum value of the display brightness value DBVI may be 2175 nits, and a minimum value thereof may be 4 nits. The maximum value and the minimum value of the display brightness value DBVI may be variously set according to a product.

Even in the same grayscale, the emission luminance of the pixel may vary according to the display brightness value DBVI. For example, when the display brightness value DBVI varies, the duty ratio of the emission signals may vary. For another example, when the display brightness value DBVI varies, different data voltages may be applied for the same grayscale. As another example, the duty ratio change of the emission signals and the data voltage change may be applied simultaneously.

The voltage provider 16 may provide the park voltages VPARK1 and VPARK2. The voltage provider 16 may receive the park voltage information VPI and generate the park voltages VPARK1 and VPARK2 at voltage levels indicated by the park voltage information VPI. In addition, the voltage provider 16 may provide the first source reference voltage VREF_H and the second source reference voltage VREC_L.

The data driver 12 may include a gamma voltage generator GMVG and a plurality of data channels DCH. The data channels DCH may be connected to the data lines DL1 to DLq. The gamma voltage generation unit GMVG may generate gamma voltages VGM and provide gamma voltages VGM corresponding to the grayscales IG received from the timing controller 11. Each data channel DCH may include an amplifier AMP. The amplifier AMP may output the input gamma voltage VGM to the data voltage VDATA and provide the data voltage VDATA to a connected data line. In this case, an upper limit of the voltage level of the amplifier AMP may be determined by the first source reference voltage VREF_H, and a lower limit of the voltage level of the amplifier amp may be determined by a second source reference voltage VREF_L.

The data driver 12 may selectively apply the data voltage VDATA and the park voltages VPARK1 and VPARK2 to the data lines DL1 to DLq. For example, the data channel DCH may include a first switch SW1 and a second switch SW2. When the data driver 12 applies the data voltage VDATA to the data lines DL1 to DLq, the first switch SW1 may be turned on. When the data driver 12 applies the park voltages VPARK1 and VPARK2 to the data lines DL1 to DLq, the second switch SW2 may be turned on.

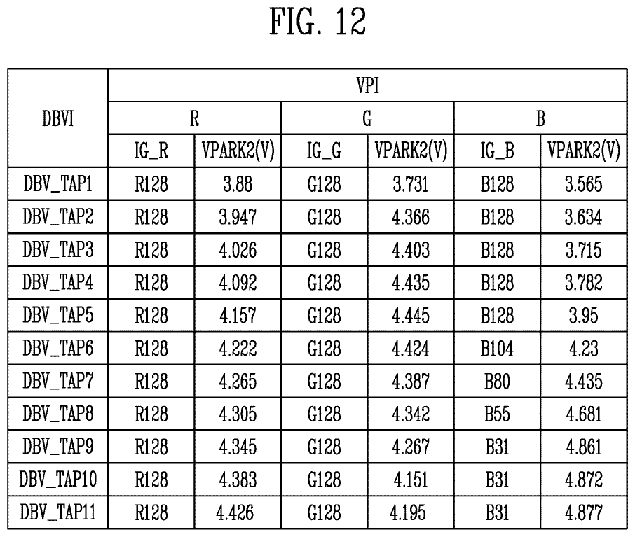

FIG. 12 is a diagram illustrating a lookup table of a park voltage determiner according to some embodiments of the present disclosure.

Referring to FIG. 12, a lookup table referred to by the park voltage determiner 17 is shown. The lookup table may be located inside the park voltage determiner 17, may be implemented as a separate memory, or may be located in a part of another memory. The lookup table may be in a state in which values of park voltages are recorded.

The display brightness value DBVI may include a plurality of reference brightness values DBV_TAP1, DBV_TAP2, DBV_TAP3, DBV_TAP4, DBV_TAP5, DBV_TAP6, DBV_TAP7, DBV_TAP8, DBV_TAP9, DBV_TAP10, and DBV_TAP11. For example, the reference brightness value DBV_TAP1 may be the largest, and the reference brightness value DBV_TAP11 may be the smallest. For example, the reference brightness value DBV_TAP1 may be 2175 nits and the reference brightness value DBV_TAP11 may be 4 nits.

The lookup table may record the second park voltages VPARK2 for the reference brightness values DBV_TAP1 to DBV_TAP11. Although the numerical values of the second park voltage VPARK2 are shown in FIG. 12, the same embodiments may be applied to the first park voltage VPARK1. Hereinafter, some repetitive description of the first park voltage VPARK1 may be omitted.

According to some embodiments, only the second park voltages VPARK2 for the reference brightness values DBV_TAP1 to DBV_T AP11 are recorded, and the second park voltage for the remaining brightness values may be calculated and derived by an interpolation method. According to some embodiments, efficient use of a memory is possible. According to some embodiments, it is also possible to write the park voltages for all brightness values in the lookup table.

According to some embodiments, the park voltage determiner 17 may independently determine the park voltage according to the colors R, G, and B of the pixels based on the display brightness value DBVI. For example, for the same display brightness value DBVI, the second park voltage VPARK2 for the first pixels of the first color R, the second park voltage VPARK2 for the second pixels of the second color G, and the second park voltage VPAK2 for the third pixels of the third color B may all be set differently. For example, in the reference brightness value DBV_TAP4, it can be seen that the second park voltage VPARK2 for the first pixels of the first color R is 4.092 V, the second park voltage VPARK2 for the second pixels of the second color G is 4.435 V, and the second park voltage VPARK2 for the third pixels of the third color B is 3.782 V, which are different from each other. According to some embodiments, it is possible to set the optimized second park voltages VPARK2 that increase the image quality and reduce the flicker phenomenon.

According to some embodiments, the park voltage determiner 17 may determine color-specific reference grayscales IG_R, IG_G, and IG_B of pixels corresponding to the display brightness value DBVI. In addition, the park voltage determiner 17 may determine reference voltages corresponding to the reference grayscales IG_R, IG_G, and IG_B as park voltages. For example, the reference grayscale may be calculated as a reference voltage by the following Equation 1.

$$VGRAY = VBlack - ( VBlack - Vwhite ) * GRAY / 511 \qquad Equation 1$$

Equation 1 assumes that each grayscale is expressed in 9 bits and has a range from 0 to 511 grayscales. VGRAY may be determined as a park voltage as a calculated reference voltage. Vblack may be a black voltage corresponding to a black grayscale (e.g., 0 grayscale), Vwhite may be a white voltage corresponding to a white grayscale (e.g., 511 grayscale), and GRAY may be a reference grayscale. In this case, at least one of the black voltage Vblack or the white voltage Vwhite may vary depending on the colors R, G, and B. Accordingly, even if the reference grayscales IG_R, IG_G, and IG_B for each color R, G, and B are the same, the reference voltage VGRAY calculated in Equation 1 may vary. The second park voltage VPARK2 may be determined to be equal to or offset from the reference voltage VGRAY.

However, the reference voltage may be calculated differently from Equation 1. For example, a weight for each color may be applied to the equation. In this case, the black voltage Vblack and the white voltage Vwhite may be the same for both colors R, G, B.

In FIG. 12, the reference grayscale G128 means 128 grayscales of the second color G. For example, reference grayscale B104 in FIG. 12 means 104 grayscale of the third color B. As described above, it is assumed that a grayscale range for one pixel is 0 to 511. The range of grayscale may vary depending on the type of display device 10.

According to some embodiments, the reference grayscale G128 of the second pixels of the second color G may be the same in all ranges of the display brightness value DBVI. For example, the second color G may be a color that contributes most to luminance among the colors R, G, and B of the pixels. For example, the second color G may be green. When the reference grayscale G128 for the second color G is changed, because a difference in luminance of an image may occur in the first mode MOD1 and the second mode MOD2, it may be preferable to set the reference grayscales G128 of the second pixels of the second color G to be the same in all ranges of the display brightness value DBVI.

According to some embodiments, the reference grayscale of the third pixels of the third color B may not be the same in all ranges of the display brightness value DBVI. For example, the reference grayscale B128 of the third pixels in the first range DBV_TAP1 to DBV_TAP5 of the display brightness value DBVI may be different from the reference grayscales B31 of the third pixels in the second range DBV_TAP9 to DBV_TAP11 of the display brightness value DBVI. For example, the third color B may be blue. Even if the reference grayscale for the third color B is changed, the effect on the luminance of the image may be small. By changing the reference grayscale for the third color B according to the display brightness value DBVI, it is possible to minimize the difference in color coordinates in the first mode MOD1 and the second mode MOD2.

In FIG. 12, the reference grayscale R128 of the first pixels of the first color G is shown to be the same in all ranges of the display brightness value DBVI. However, according to some embodiments, the reference grayscale R128 of the first pixels of the first color G may not be the same in all ranges of the display brightness value DBVI. For example, similar to the case of the third color B, the reference grayscale R128 of the first pixels of the first color G may be set.

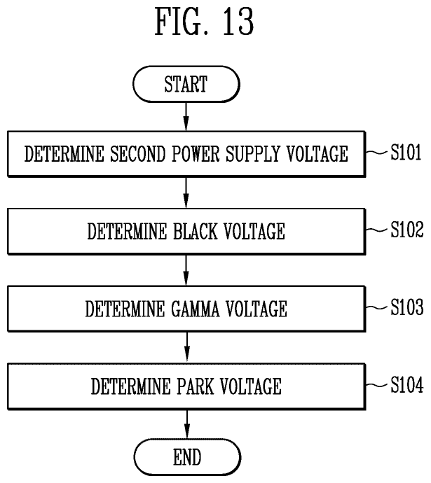

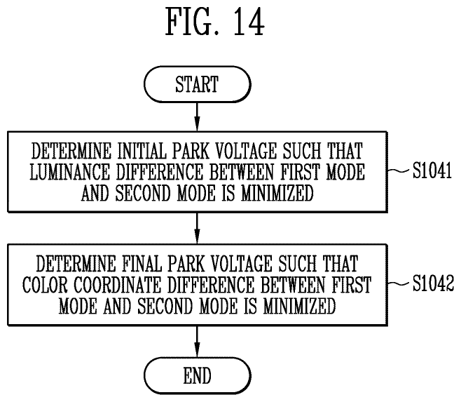

FIGS. 13 and 14 are diagrams for describing aspects of a process of determining a park voltage. Although FIGS. 13 and 14 illustrate various operations in a process of determining a park voltage, embodiments according to the present disclosure are not limited thereto, and according to various embodiments, the process may include additional operations, or fewer operations, or the order of operations may vary, unless otherwise stated or implied, without departing from the spirit and scope of embodiments according to the present disclosure.

The process of FIGS. 13 and 14 may be performed by a measurement device including a luminance meter in a factory before the product of the display device 10 is shipped. Because the characteristics and distribution of the pixels may be different for each display device 10, it is necessary to individually set the second power supply voltage, the black voltage, the gamma voltage, and the park voltage of the display device 10.

Referring to FIG. 13, first, the measurement device may determine a second power supply voltage ELVSS of the display device 10 (S101). Referring to FIG. 2, the second power supply voltage ELVSS may be a common voltage applied to the cathode electrodes of the light emitting elements LD of pixels.

Next, the measurement device may determine a black voltage of the display device 10 (S102). The black voltage is a voltage corresponding to the zero grayscale, and may be the same or different for each color. For the black voltage, refer to Equation 1. If the display device 10 cannot display a complete black image, a black lifting phenomenon may occur.

Next, the measurement device may determine the gamma voltage of the display device 10 (S103). For the same grayscale, the gamma voltage may be set differently according to the display brightness value DBVI. For this, refer to the description of FIG. 11.

Next, the measurement device may determine the park voltage of the display device 10 (S104). The first park voltage VPARK1 may be determined to minimize an effect on image quality in the first mode MOD1, and the second park voltage VPARK2 may be determined to reduce flicker occurrence in the second mode MOD2.

Referring to FIG. 14, detailed steps for the step S104 of determining the park voltage by the measuring device is shown. Steps S1041 and S1042 described below may all be applied to the determination of the first park voltage VPARK1 or the second park voltage VPARK2.

First, the measurement device may determine the initial park voltage such that a luminance difference between the first mode MOD1 and the second mode MOD2 is minimized (S1041) (e.g., below a set or predetermined value). For example, the measurement device can measure the first luminance in the first mode MOD1 and the second luminance in the second mode MOD2 with respect to a specific position of the pixel unit 14. In this case, the input frame for the image in the first mode MOD1 and the input frame for the image in the second mode MOD2 may be the same. The luminance difference may be calculated as shown in Equation 2 below.

$$VRR\_L = ( MOD2\_L / MOD 1 \_L ) - 1 \qquad Equation 2$$

Here, VRR_L may be an index for a luminance difference between the first mode MOD1 and the second mode MOD2, MOD2_L may be a second luminance in the second mode MAD2, and MOD1_L may be the first luminance in first mode MOD1, respectively. The measuring device may determine the initial park voltage so that VRR_L is close to 0. Because VRR_L may be negative, when the initial park voltage is determined so that VRR_L is close to 0, the measurement device may determine the initial park voltage so that the luminance difference between the first mode MOD1 and the second mode MOD2 is minimized.

Next, the measurement device may determine the final park voltage such that the color coordinate difference between the first mode MOD1 and the second mode MOD2 is minimized (S1042) (e.g., below a set or predetermined threshold value). This final park voltage may be the first park voltage VPARK1 or the second park voltage VPARK2.

For example, the measurement device can measure the first color coordinate in the first mode MOD1 and the second color coordinate in the second mode MOD2 with respect to the specific position of the pixel unit 14. In this case, the input frame for the image in the first mode MOD1 and the input frame for the image in the second mode MOD2 may be the same. The color coordinate difference may be calculated as shown in Equation 3 below.

$$duv = \sqrt{{( MOD 1 u - MOD 2 u )}^{2} + {( MOD 1 v - MOD 2 v )}^{2}} \qquad Equation 3$$

Here, duv may be an index for a color coordinate difference between the first mode MOD1 and the second mode MOD2, MOD1u may be a u color coordinate of a Luv color space in the first mode MAD1, MOD2u may be a u color coordinate of a Luv color space in the second mode MOD2, MOD1v may be a v color coordinate of the Luv color space in the first mode MAD1, and MOD2v may be a v color coordinate of the Luv color space in the second mode MOD2. The measuring device may determine the final park voltage so that the duv is minimized. According to some embodiments, coordinates of different color spaces may be used in calculating the color coordinate difference.

According to some embodiments, steps S1041 and S1042 may not be performed in advance by the measurement device, but at least some steps may be performed during driving of the display device 10 by the park voltage determiner 17.

The display device according to some embodiments may be applied to various electronic devices. The electronic device according to some embodiments includes the above-described display device, and may further include a module or device having an additional function other than the display device.

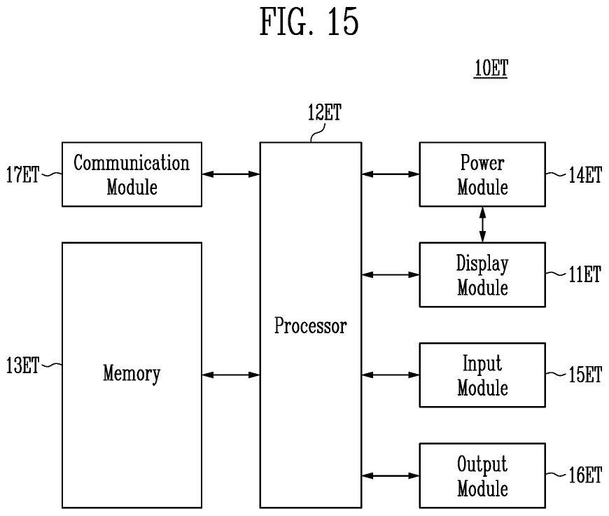

FIG. 15 is a block diagram of an electronic device according to some embodiments. Referring to FIG. 15, an electronic device 10ET according to some embodiments may include a display module 11ET, a processor 12ET, a memory 13ET, and a power module 14ET. The display module 11ET may be represented by a display device.

The processor 12ET may include at least one of a central processing unit (CPU), an application processor (AP), a graphics processing unit (GPU), a communication processor (CP), an image signal processor (ISP), or a controller. According to some embodiments, the processor 12ET may be provided divided into two or more from a functional or structural point of view. For example, the processor 12ET may include a main processor in the form of a first drive chip including a central processing unit, and an auxiliary process in the form of the second drive chip including a controller that receives an image signal from the main processor and processes the image signal to meet an interface specification of the display module 11ET. The processor 12ET may provide image data. The display module 11ET may display an image based on grayscales of image data.

The memory 13ET may include at least one of a non-volatile memory or a volatile memory. Data information necessary for the operation of the processor 12ET or the display module 11ET may be stored in the memory 13ET. When the processor 12ET executes an application stored in the memory 13ET, an image data signal and/or an input control signal are transmitted to the display module 11ET, and the display module 11ets may process the received signal and output image information through a display screen.

The power module 14ET may include a power supply module such as a power adapter or a battery device, and a power conversion module that converts power supplied by the power supply module to generate power required for operation of the electronic device 10ET. The power conversion by the power conversion module may include, but is not limited to, DC-DC conversion, AC-DC conversion, and DC-AC conversion.

The electronic device 10ET may further include an input module 15ET, a non-image output module 16ET, and/or a communication module 17ET.

The input module 15ET may provide input information to the processor 12ET and/or the display module 11ET. The input module 15ET may include physical buttons, keyboards, microphones, as well as various sensor modules. Examples of the sensor module may include a touch sensor, a pressure sensor, a distance sensor, a position sensor, a digitizer, a motion recognition sensor, a camera sensor, a light receiving sensor, a photoelectric conversion sensor, a temperature sensor, as well as a biometric sensor such as a blood pressure sensor, a blood glucose sensor, an electrocardiogram sensor, a heart rate sensor, and the like.

The non-image output module 16ET may receive information other than the image received from the processor 12ET and provide it to the user. Examples of the non-image output module 16ET include an acoustic module, a haptic module, an emission module, and the like, and may include other functional modules unique to an electronic device (for example, a cooling module of a refrigerator, and the like).

The communication module 17ET is a module for transmitting and receiving information between the electronic device 10ET and an external device, and may include a receiving unit and a transmitting unit. The communication module 17ET may include various wireless communication modules such as a mobile communication module, a Wi-Fi module, and a Bluetooth module, or various wired communication modules.

At least one of the above-described components of the electronic device 10ET may be included in the display device according to the above-described embodiments. In addition, some of the individual modules functionally included in one module may be included in the display device, and other parts may be provided separately from the display device. For example, the display device may include a display module 11ET, and the processor 12ET, the memory 13ET, and the power module 14ET may be provided in the form of other devices in the electronic device 10ET other than the display device. As another example, the power module 14ET may be provided in the display device, and power may be supplied to the processor 12ET and the memory 13ET provided in the electronic device 10ET other than the display device, which is not limited to the above example.

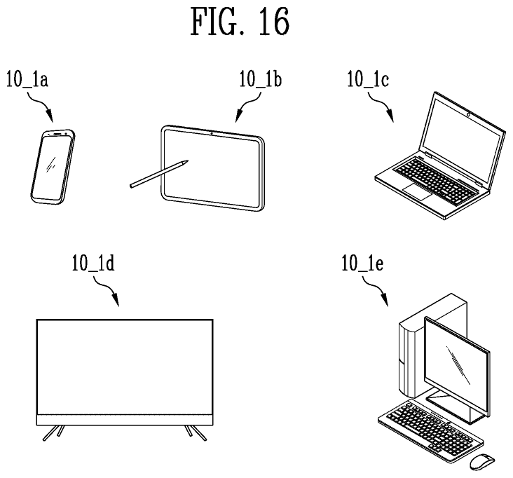

FIGS. 16 to 18 are schematic diagrams of an electronic device according to various embodiments. FIGS. 16 to 18 illustrate examples of various electronic devices to which a display device according to embodiments is applied.

FIG. 16 illustrates a smartphone 10_1a, a tablet PC 10_1b, a laptop 10_1c, a TV 10_1d, and a desk monitor 10_1e as examples of electronic devices.

The smartphone 10_1a may include an input module such as a touch sensor and a communication module in addition to the display module 11ET. The smartphone 10_1a may process information received through a communication module or other input module to display information through a display module of a display device.

Tablet PC 10_1b, laptop 10_1c, TV 10_1d, and desk monitor 10_1e also include a display module and an input module, similar to smartphone 10_1a, and may further include a communication module in some cases.

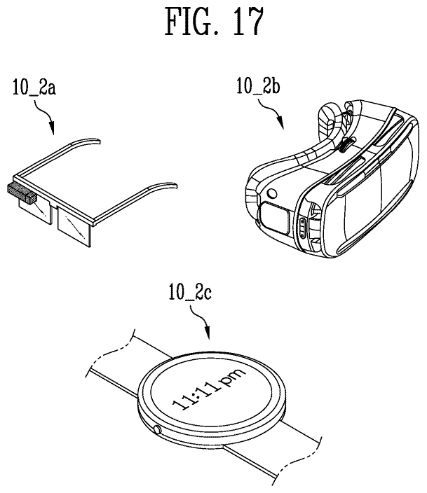

FIG. 17 illustrates a case in which an electronic device including a display module is applied to a wearable electronic device. The wearable electronic device may be a smart glasses 10_2a, a head mounted display 10_2b, a smart watch 10_2c, or the like.

The smart glasses 10_2a and the head mounted display 10_2b may include a display module that emits a display image and a reflector that reflects the emitted display screen and provides it to the user's eyes, thereby providing a screen of virtual reality or augmented reality to the user.

The smart watch 10_2c includes a biometric sensor as an input device, and may provide biometric information recognized through the biometric sensor to a user through a display module.

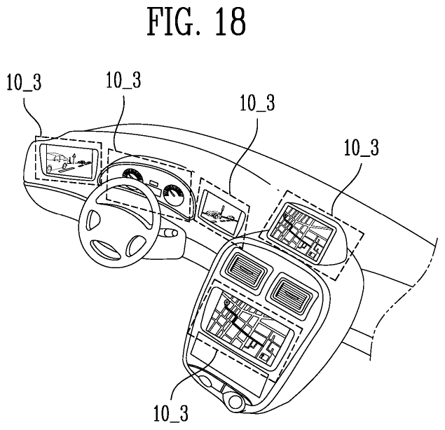

FIG. 18 illustrates a case where an electronic device including a display module is applied to a vehicle. For example, the electronic device 10_3 may be applied to an instrument panel, a center fascia, or the like of a vehicle, or may be applied to a CID (Center Information Display) located on a dashboard of a vehicle, a room mirror display in place of a side mirror, or the like.

According to some embodiments, the electronic device to which the display device according to embodiments is applied may include not only devices mainly displaying a screen such as a billboard, an electric signboard, and a game machine, but also various home appliances displaying information through a display module such as a refrigerator, a washing machine, a dryer, an air conditioner, a robot cleaner, and the like. In addition, when the display module has a function of transmitting light, it may be applied to an electronic device such as a smart window or a transparent display device that displays a background and a display image together. The type of the electronic device according to the embodiments is not limited by the above-described example, and various other electronic devices that are not illustrated may be applied.

The display device and the electronic device according to the present disclosure may maintain high image quality while reducing power consumption.

The drawings and detailed description of the disclosure referred to so far are merely illustrative of the disclosure, which has been used merely for the purpose of describing the disclosure and not for the purpose of limiting the scope of the disclosure as defined in the claims. Therefore, those skilled in the art will appreciate that various modifications and equivalent embodiments are possible therefrom. Therefore, the true technical protection scope of the present disclosure should be determined by the technical idea of the appended claims, and their equivalents.

What is claimed is:

1. A display device comprising:
a pixel unit including pixels connected to data lines;
a data driver configured to selectively apply a data voltage and a park voltage to the data lines;
a voltage provider configured to provide the park voltage; and
a park voltage determiner configured to independently determine the park voltage according to colors of the pixels based on a display brightness value.

2. The display device of claim 1,
wherein the display device is configured to display an image in a plurality of modes,
wherein the plurality of modes include a first mode of displaying an image at a first frequency and a second mode of displaying an image at a second frequency,
wherein the park voltage is a first park voltage, and
wherein the first park voltage is provided to the data lines in the first mode for a first period.

3. The display device of claim 2,
wherein the park voltage is a second park voltage, and
wherein the second park voltage is provided to the data lines in the second mode for a second period.

4. The display device of claim 3,
wherein the second frequency is smaller than the first frequency, and
wherein the second period is longer than the first period.

5. The display device of claim 1,
wherein the park voltage determiner is configured to determine a reference grayscale for each color of the pixels corresponding to the display brightness value, and to determine a reference voltage corresponding to the reference grayscale as the park voltage.

6. The display device of claim 5,
wherein the pixels include first pixels of a first color, second pixels of a second color, and third pixels of a third color, and
wherein the reference grayscale of the second pixels is equal in all ranges of the display brightness value.

7. The display device of claim 6,
wherein the reference grayscale of the third pixels in a first range of the display brightness value is different from the reference grayscales of the third pixels of a second range of the display brightness value.

8. The display device of claim 7,
wherein the park voltage is recorded in a lookup table.

9. The display device of claim 1,
wherein the display device is configured to display an image in a plurality of modes,
wherein the plurality of modes include a first mode of displaying an image at a first frequency and a second mode of displaying an image at a second frequency, and
wherein the park voltage determiner is configured to determine an initial park voltage such that a luminance difference between the first mode and the second mode is below a predetermined value.

10. The display device of claim 9,
wherein the park voltage determiner is configured to determine a final park voltage so that a color coordinate difference between the first mode and the second mode is below a predetermined threshold, and
wherein the final park voltage is the park voltage.

11. An electronic device comprising:
a processor configured to provide image data; and
a display device configured to display an image based on grayscales of the image data,
wherein the display device includes:
a pixel unit including pixels connected to data lines;
a data driver configured to selectively apply a data voltage and a park voltage to the data lines;
a voltage provider configured to provide the park voltage; and
a park voltage determiner configured to independently determine the park voltage according to colors of the pixels based on a display brightness value.

12. The electronic device of claim 11,
wherein the display device is configured to display an image in a plurality of modes,
wherein the plurality of modes include a first mode of displaying an image at a first frequency and a second mode of displaying an image at a second frequency,
wherein the park voltage is a first park voltage, and
wherein the first park voltage is provided to the data lines in the first mode for a first period.

13. The electronic device of claim 12,
wherein the park voltage is a second park voltage, and
wherein the second park voltage is provided to the data lines in the second mode for a second period of time.

14. The electronic device of claim 13,
wherein the second frequency is smaller than the first frequency, and
wherein the second period is longer than the first period.

15. The electronic device of claim 11,
wherein the park voltage determiner is configured to determine a reference grayscale for each color of the pixels corresponding to the display brightness value, and to determine a reference voltage corresponding to the reference grayscale as the park voltage.

16. The electronic device of claim 15,
wherein the pixels include first pixels of a first color, second pixels of a second color, and third pixels of a third color, and
wherein the reference grayscale of the second pixels is equal in all ranges of the display brightness value.

17. The electronic device of claim 16,
wherein the reference grayscale of the third pixels in a first range of the display brightness value is different from the reference grayscale of the third pixels of a second range of the display brightness value.

18. The electronic device of claim 17,
wherein the park voltage is recorded in a lookup table.

19. The electronic device of claim 11,
wherein the display device is configured to display an image in a plurality of modes,
wherein the plurality of modes include a first mode of displaying an image at a first frequency and a second mode of displaying an image at a second frequency, and
wherein the park voltage determiner is configured to determine an initial park voltage such that a luminance difference between the first mode and the second mode is below a predetermined value.

20. The electronic device of claim 19,
wherein the park voltage determiner is configured to determine a final park voltage so that a color coordinate difference between the first mode and the second mode is below a predetermined threshold, and
wherein the final park voltage is the park voltage.
